(19) United States
(12) Patent Application Publication
(10) Pub. No.: US 2023/0079169 A1
(43) Pub. Date: Mar. 16, 2023

(54) A RESERVOIR OR POUCH, IN USE, BONDED OR CONNECTED TO A SPONGE OR WASHING/CLEANING APPLICATOR MEANS

(71) Applicant: Jagjeet Singh KUDHAIL, Coldfield (GB)

(72) Inventor: Jagjeet Singh KUDHAIL, Coldfield (GB)

(21) Appl. No.: 17/801,133

(22) PCT Filed: Feb. 18, 2021
(86) PCT No.: PCT/GB2021/000019

§ 371 Date: Aug. 19, 2022

(30) Foreign Application Priority Data
Feb. 20, 2020 (GB) 2002462.6

(51) Int. Cl. A47L 13/19; A41D 19/00; A47K 7/03; A01K 13/00

(52) U.S. Cl. CPC A47L 13/19; A41D 19/0079; A47K 7/03; A01K 13/001

(57) ABSTRACT

An assembly of an upper, oval shaped reservoir/pouch bonded or moulded with a lower peripheral hand grip portion having a rectangular well or recess snugly receiving a standard dimension off the shelf rectangular sponge. The reservoir/pouch has a centrally located inlet valve for receiving a suitable cleansing/washing agent and a single outlet nozzle positioned on a lower surface of the reservoir. The reservoir/pouch occupies a substantial volume in relation to sponge to avoid the necessity of frequent filling with cleansing/washing agent. The hand grip portion has a skirt S with opposed, vertical curved wall ribbing and that can be gripped and squeezed together to dispense agent from the reservoir/pouch through the outlet nozzle into and through pores in the sponge, in a manner that should readily be envisaged.

This invention relates to improvements in or relating to cleaning or washing aids and is more particularly concerned with a glove provided with a reservoir or pouch, in use, containing a cleaning, washing or treatment agent or material e.g. a cleansing liquid/fluid for use in domestic, medical or industrial applications.

There have been numerous proposals for gloves having a re-fillable reservoir of cleansing liquid/fluid and means to dispense said fluid/liquid through outlet nozzles onto the surface of an item or animal/person to be cleaned or washed.

Indeed, the Applicant has previously patented such a glove being the subject of Patent Specification No. GB 2542208.

In many of the prior proposals the reservoir is formed as an integral part of the glove whereas it is believed the arrangement shown in Patent Specification No. GB 2542208 is particularly advantageous because the reservoir/pouch is formed separately to the glove.

However, although it is believed the glove shown in Patent Specification No. GB 2542208 should work in practice, nevertheless, it is now believed that the design tends to have certain disadvantages or could be improved in some respects.

The design as disclosed in said Patent Specification No. GB 2542208 requires a separate pouch to be installed on the inside of a (rubber) glove and such installation somewhat, disadvantageously, requires modifications to be made to e.g. a standard rubber/elastomeric glove, in order to accommodate such installation. Such modifications may be highly complex or much more complex than might be envisaged as custom jigs and dies would be required, along with a multi-stage modification and assembly approach necessary to produce a finished product.

A further perceived possible disadvantage of such a glove is that it may provide a detrimental experience for a user having a hand in the glove in direct contact with the pouch as it is internal, yielding an uncomfortable/unsettling, perhaps unnecessarily squishy, feeling. Still further, internal installation of the pouch may conceivably hinder performance by pressure being unwittingly applied to elements of the pouch restricting flow of fluid/liquid material contained therein, when being dispensed through outlet valves of the glove.

Additionally, where a pouch is provided inside such a glove as aforesaid there may be a potential hazard if the pouch leaks or bursts on to the user's hand inside the glove depending upon the nature of the cleaning agent or material contained in the pouch. Even should such agent or material be safe to come into contact with a user's skin, it may be unpleasant or a messy chore for the user to clean and dry the hand in addition to the interior of the glove for re-use.

The Applicant is concerned with making a modification or improvement to the arrangement as shown in said Patent Specification GB 2542208. Such a modification or improvement may result in significant reductions in tooling costs, assembly costs, time, and material and improve efficiency and scalability.

Accordingly, it is an object of the present invention to provide a cleaning/washing aid which at least alleviates one or more of the aforementioned, or other, disadvantages associated with such aids or which is improved in at least some respect.

According to the present invention there is provided a cleaning or washing aid comprising a glove and a separately formed, self-contained reservoir or pouch, in use, bonded or attached to the outside of the a palm of the glove, said reservoir/pouch having an inlet for receiving a cleansing or washing agent and at least one outlet nozzle or valve through which said agent may be dispensed.

In most embodiments of the present invention it envisaged that the inlet will be readily accessible (particularly where the aid is for re-use) and, preferably, located at or adjacent to the outside of the palm of the glove.

In embodiments of the present invention, the cleaning/washing aid may be provided with cleaning/scouring/agitating/polishing/treatment/applicator means such as a sponge and/or brush and/or textured or stippled surface to spread and rub the cleansing/washing agent onto the surface of an item/person/animal requiring treatment.

Preferably, the pouch/reservoir is manufactured separately to the glove with an exterior sponge or other cleaning/scouring/agitating/polishing/treatment/applicator surface (e.g. brush or textured cloth) attached thereto to create a unit or sub-assembly that is bonded/attached to the outside of the palm of the glove. Usually, the inlet will be visible or exposed on or adjacent to the palm of the glove, possible extending below the sponge (or cleaning/scouring/agitating/polishing/treatment/applicator).

Any suitable bonding material or attachment method may be utilised.

By the present invention, advantageously, it is envisaged at least in most embodiments that a standard rubber/elastomeric glove can be employed with no modifications needing to be made to said glove prior to bonding/attaching the pouch to the glove and therefore, no complex jigs/dies need be required.

In one embodiment of a washing/cleaning aid in accordance with the present invention the pouch/reservoir is provided with a single outlet nozzle/valve, preferably, located on the outside of the palm of the glove thereby, advantageously, reducing the complexity of the design and assembly resulting in a reduced production cost. Other embodiments may include a plurality of outlet nozzles e.g. located on fingertips of the pouch/reservoir itself.

Further according to the present invention there is provided a method of making a washing/cleaning aid comprising:
1) Manufacturing a self-contained reservoir or pouch having an inlet and at least one outlet nozzle or valve,
2) Bonding or attaching said reservoir or pouch to the outside of a palm of a glove (of standard format)
3) Preferably, attaching said reservoir/pouch to a sponge or other exterior applicator surface, preferably as a unit or sub-assembly bonded or attached to the outside of the palm of said glove.

Further according to the present invention there is provided a washing/cleaning aid or method having any feature/s or function/s derivable from this description and/or FIGURES of the drawings.

Further advantageous features of the present invention will be apparent from the following description and drawings.

An embodiment of a cleaning/washing aid in accordance with the present invention will now be described, by way of example only, with reference to the accompanying, somewhat schematic, FIGURES of the drawings, in which:

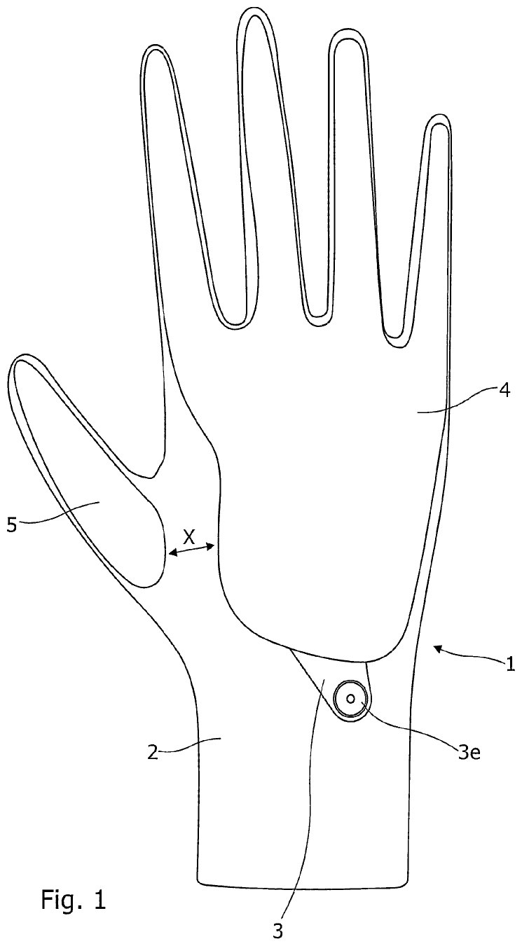

FIG. 1 shows a front view of the cleaning/washing aid including a glove for fitting on the left hand of a user;

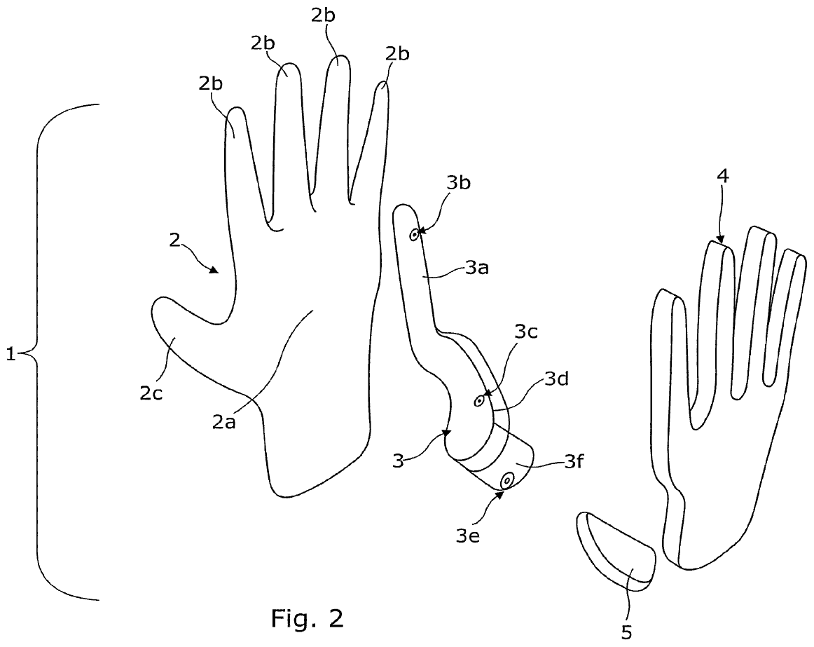

FIG. 2 shows an exploded view of the components of FIG. 1;

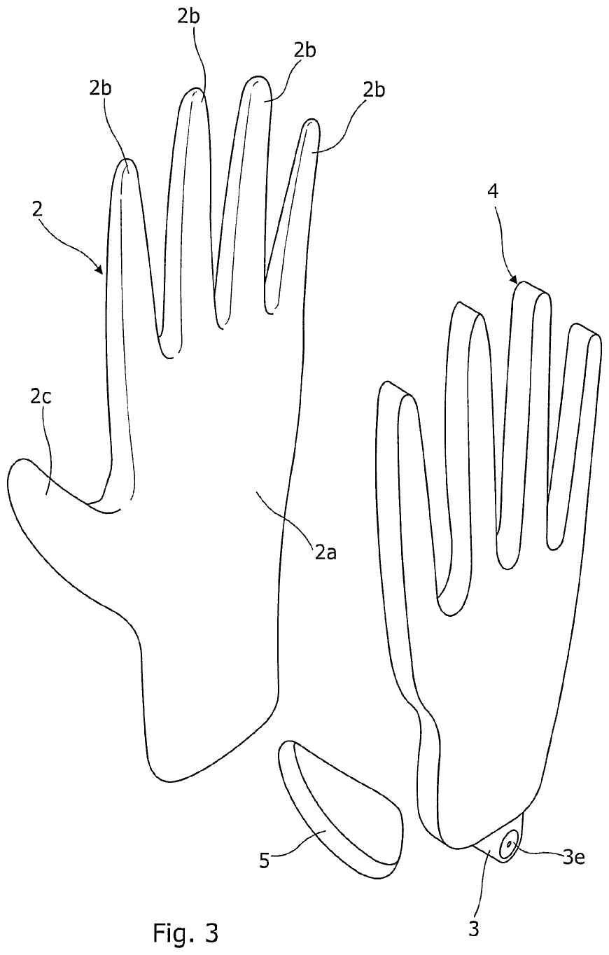

FIG. 3 shows a partly exploded view of FIG. 1 with a pouch/reservoir attached to a sponge member as a unit prior to bonding to the glove, and

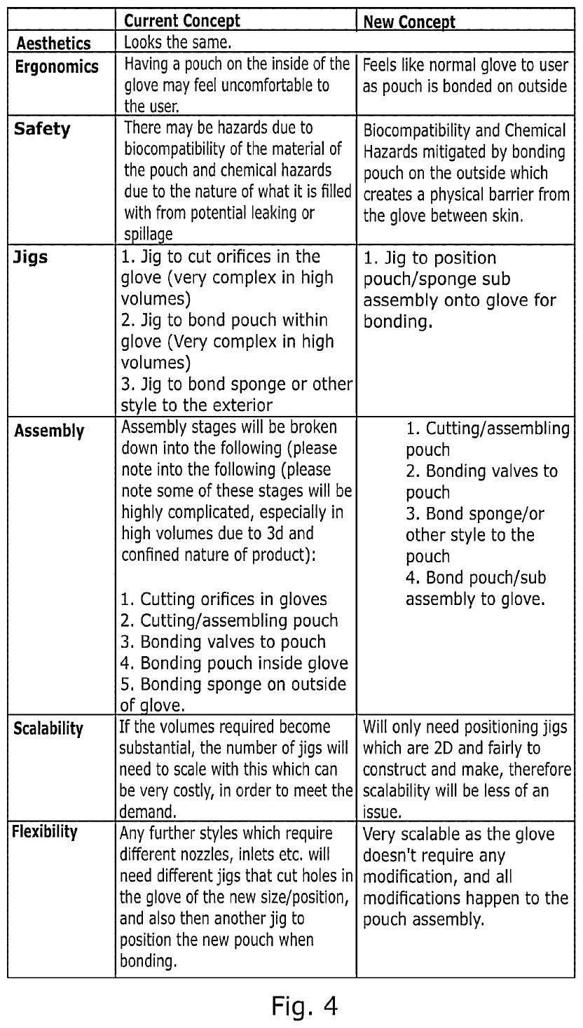

FIG. 4 shows a comparison table relating production features of a current concept applicable to embodiments of washing/cleaning aids of Patent Specification No. GB 2542208 with production features of the new concept applicable to embodiments of washing/cleaning aids in accordance with the present invention.

Referring to FIGS. 1 to 3, a washing/cleaning aid 1 has a standard, off the shelf, left-handed, rubber/elastomeric glove 2 having a self-contained, closed pouch 3 (see FIG. 2 in particular) and flat, four fingered, exterior, sponge member 4 bonded thereto.

The pouch 3 and sponge member 4 are manufactured as a unit or sub-assembly (see FIG. 3) that is bonded to the palm 2a and fingers 2b of the rubber glove 2 as shown in FIG. 1. The pouch 3 itself may be manufactured by ultrasonic welding and the sponge member 4 and pouch secured to the glove by a suitable adhesive or ultrasonic welding.

A separate, thumb, sponge member 5 is bonded directly to the inside of the thumb 2c of the glove 2, as shown. It is believed that providing a separate, thumb, sponge member 5 (more particularly with a gap between members 5 and 6) is advantageous instead of providing sponge members 5 and 6 as an integral unit; as such a design allows a greater ease of use of the user in dispensing cleaning/washing agent or fluid or the like from the pouch 3 and use of said washing/cleaning aid 1.

The pouch 3 as shown is of a generally known configuration and may be of any suitable material such as polythene, PVC (polyvinyl chloride) or the like. In the embodiment as shown, the pouch 3 is generally elongate and has an upper part 3a arranged, when attached to the glove 2, to extend along the inside of the glove forefinger 2b. An outlet nozzle or valve 3b (which may be of a generally known type) is provided at the finger tip of upper part 3a and a further outlet nozzle or valve 3c (which again may be of a known type) is provided in a lower, palm part 3d of the pouch 3.

An inlet nozzle or valve 3e (which again may be generally of a known type) is exposed and provided at a bottom end 3f of pouch 3, said inlet nozzle being readily accessible as it extends below, and is not covered by, sponge member 4 when attached to the glove 2.

It is to be noted that the inlet nozzle 3e is positioned conveniently at the bottom of the palm 2a of the glove adjacent to the inside of the wrist area 2c of the glove 2.

Once the components 2, 3, 4, 5 have been assembled to produce the cleaning/washing aid 1 an agent or material (not shown) suited to the particular cleaning/washing task envisaged can be introduced into the pouch 3 through inlet nozzle 3e.

Whilst it is envisaged that a wet, liquid agent will usually be employed it is possible that a dry powder or gel could be used.

Flexing the forefinger 2b and squeezing the pouch 3 should enable the cleaning/washing agent to be dispensed through the outlet nozzles 3b and 3c at a controlled rate into and through pores of sponge member 4.

Sponge members 4 and 5 can be utilised in a generally known manner to spread and apply the cleaning/washing agent to the item or animal/person requiring treatment.

It is possible, in an alternative embodiment (not shown) that the sponge member is replaced by an alternative applicator/scouring/treatment member such as a brush or textured/stippled surface having pores to allow the passage of cleaning/washing agent therethrough.

The configuration of the pouch 3 may be varied to suit. In particular, advantageously, and to reduce costs, the pouch may be provided with a single outlet nozzle/valve, preferably, located in the palm of the glove, in use. Thus, advantageously, the pouch may be of a shape located solely or completely within the palm of the glove avoiding the necessity for any finger portions. It is believed that adequate flow of the cleaning/washing agent should be achievable at least for the majority of requirements.

It is possible in some designs (not shown) that the pouch may be provided with a plurality of outlet nozzles greater than two e.g the pouch may have two or more finger portions extending along the inside of particular fingers 2b with nozzles at associated finger tips of the pouch fingers.

Any convenient pouch configuration, number of outlet nozzles and location of said nozzles may be provided to suit required needs.

In some instances, the pouch may not be re-fillable and the washing/cleaning aid may be designed to be disposable after one use. This may be applicable in medical applications to help prevent spread of infection or e.g. industrial application where contamination is a risk factor.

Advantageously, embodiments of the present invention should allow a much simpler and more cost effective production of a cleaning/washing aid by incorporating an off the shelf standard glove (requiring no cutting or removal of material to accommodate an interior pouch) to which can be attached a selected unit or sub-assembly including a pouch and preferably an additional (porous) member such as a sponge or stippled applicator.

As stated, it is believed the present invention (more particularly as illustrated by the embodiment described) has very significant advantages over and above known arrangements and in particular over and above a possible current production concept (current concept) for embodiments relating to the Applicant's own proposals in Patent Specification No. GB 2542208.

By way of further explanation, FIG. 4 is a comparison table which outlines some of the advantages of embodiments of the washing/cleaning aid in accordance with the present invention and production method thereof (new concept) over and above said current concept.

Although the embodiment of the cleaning/washing aid 1 shown in FIGS. 1 to 3 relates to a left-handed glove 2 configuration it should be appreciated how the present invention may be applicable to a right-handed glove. Advantageously, it would merely be necessary for the pouch 3 to be bonded/attached to the reverse side of the sponge member 4 (or other applicator). Thus, the same component parts could be used with either a left or right-handed glove.

Thus, according to the present invention there may be provided a kit of parts comprising a pair of gloves and a plurality of pouches and, preferably, a plurality of sponge members (or other scourer/applicator means).

Although not shown, it is possible the sponge member (or other applicator means) may be provided with a recess for receiving the pouch/reservoir.

As a further development of the present invention (not shown), the sponge member 4 and/or 5 (or other scourer/applicator means) may be removably attached to the glove to enable replacement with a new scourer/applicator means e.g. if the original scourer/applicator means becomes worn out/damaged or dirty or if a different type of scourer/applicator means is required to suit the task in hand. The removable attachment may be a hook and loop fastener of the ‘VELCRO’ type.

It is possible that the pouch and/or applicator means and/or glove may be made from bio-degradable material/s such as coconut fibre.

Still further it is possible that a combination of pouch/applicator means may be utilised without a glove at all or without the glove being attached to said combination. The pouch may be attached to a scourer/applicator means such as a sponge (usually on the back of the sponge) and/or glove e.g. by ultrasonic welding or otherwise (the attachment may be permanent or releasable—e.g. permitting use of the scourer/applicator means with a new pouch or vice versa—).

The pouch may be refillable or otherwise (re-usable or disposable) depending upon the intended use.

In an embodiment of the present invention (not shown) as an option a part of a rubber glove (or other waste rubber material or the like) could be (heat) sealed on the palm of another glove to create a pouch/reservoir with the sponge/applicator means placed over the top of said pouch/reservoir. Advantageously, in this way, any disused or scrap rubber/gloves could be utilised/salvaged providing a ‘greener’ contribution to the environment.

Further developments of embodiments of a reservoir/pouch in accordance with the present invention and combination of reservoir/pouch and sponge/scourer/applicator are discussed below:

Thus, according to a further aspect of the present invention there is provided a reservoir or pouch, in use, bonded or connected to a sponge or washing/cleaning applicator means , said reservoir/pouch having an inlet for receiving a cleansing or washing agent and at least one outlet nozzle or valve through which said agent may be dispensed.

In one embodiment, according to said further aspect, advantageously, the reservoir/pouch has a hand grip portion that preferably holds or (removably) secures the sponge/applicator means—preferably squeezing the hand grip portion dispenses the cleansing or washing agent from the reservoir/pouch from said at least one outlet nozzle onto or into said sponge/applicator means.

The hand grip portion may be provided with a suitably sized recess or well for snugly receiving the sponge/applicator means (that may be an of the shelf product such as a rectangular, oval or circular sponge—possibly with an additional outer scourer layer). The recess/well will usually be located on the underside of the hand grip portion and/or the inlet will usually be located on an upper part of the reservoir/pouch. Said at least one outlet nozzle or valve will usually be on a lower part of the reservoir/pouch adjacent the sponge/applicator means.

The reservoir/pouch may be bonded or moulded to the hand grip portion. The reservoir/pouch may be manufactured as an integral one part unit or as a two part assembly (separate reservoir/pouch and hand grip parts). The reservoir/pouch may be replaceable on the hand grip portion.

The sponge/applicator means may be removable from the hand grip portion to allow replacement when worn out or dirty or may be permanently bonded thereto.

The hand grip portion may be made from any suitable material such as silicone or other plastics/elastomeric materials.

In an alternative embodiment of a reservoir/pouch according to this further aspect of the present invention, the reservoir pouch is connected to an upper surface of a sponge/applicator means. The sponge/applicator means may be bonded to said upper surface. The sponge/applicator means may be any desired shape with the reservoir/pouch complementing said shape.

It is envisaged that the pouch/reservoir will usually be refillable with washing/cleansing agent although it is possible the pouch reservoir is not refillable and thus may not even be provided with an inlet separate to the outlet nozzle.

Advantageously, the reservoir/pouch is of a substantial size (perhaps 30% to 100% the volume of the sponge/applicator means) and/or spans (or perhaps 30% to 100%) substantially an upper surface of the sponge/applicator means. In this way, frequent filling of the pouch/reservoir with washing agent is avoided and, at least in some embodiments, dispensing of the washing agent can be accomplished in an easy, controlled manner, preferably, by simply squeezing or pressing the pouch/reservoir (and/or hand grip where provided) rather than e.g. by pressing a control button to release agent (the provision of which may increase production costs and provide a reduction in controlled, responsive agent release). Even so, it is possible in some embodiments that, additionally or alternatively, a control button is provided to release or help release said agent.

Further advantageous features of the present invention will be apparent from the following description and drawings.

Embodiments of reservoir/pouches and sponges/applicator means in accordance with this further aspect of the present invention will now be described, by way of example only, with reference to the accompanying, somewhat schematic, FIGURES of the drawings, in which:

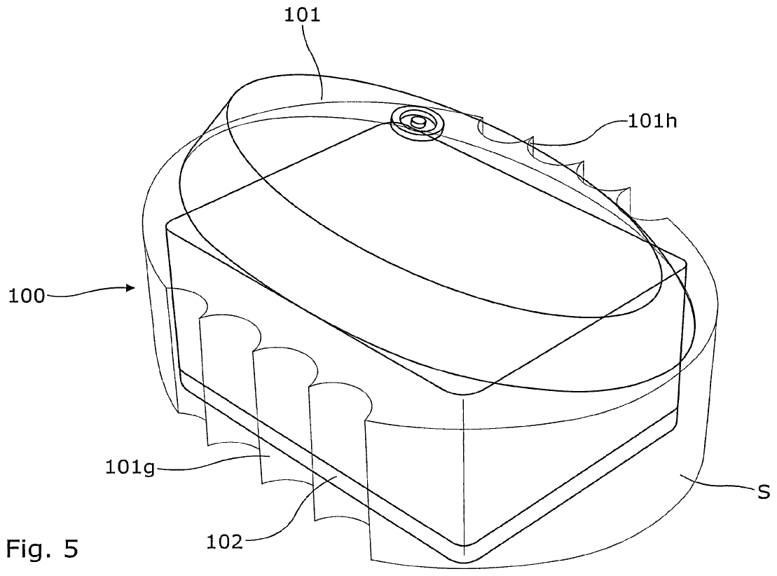

FIG. 5 shows a perspective concept view of an embodiment of a reservoir/pouch having a hand grip portion fitted with an off the shelf rectangular sponge;

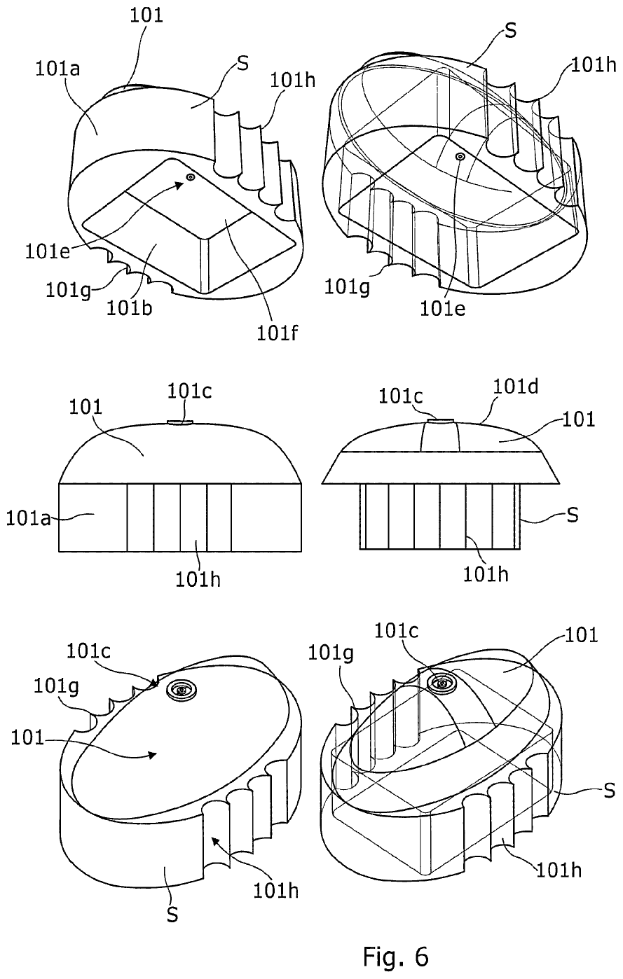

FIG. 6 shows three line drawings and three comparative concept views of the reservoir/pouch with hand grip portion, and

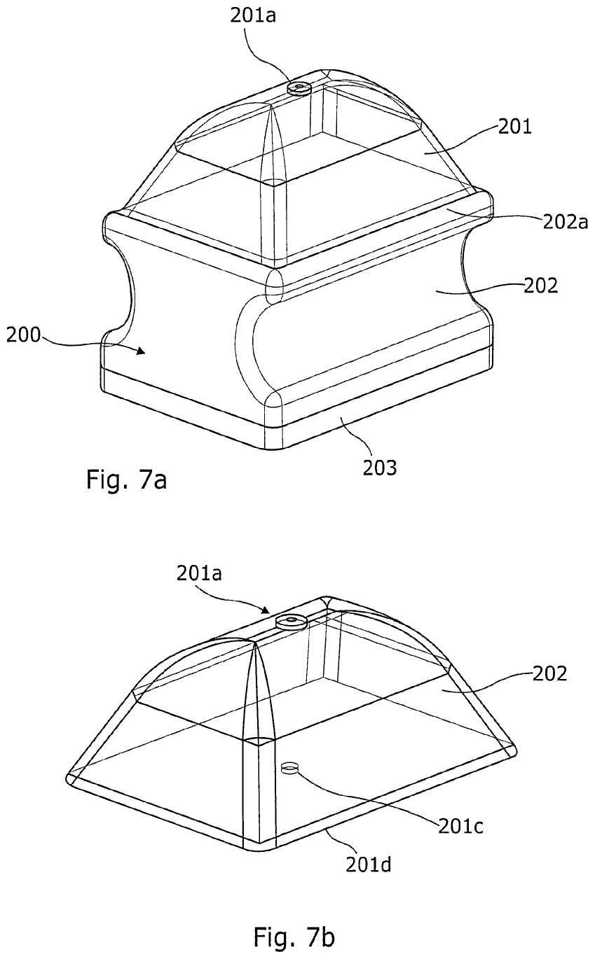

FIG. 7a shows a further embodiment of a reservoir/pouch in concept view connected to a sponge with FIG. 7b showing the reservoir/pouch itself in concept view.

FIG. 5 shows an assembly 100 of an upper, oval shaped reservoir/pouch 101 bonded or moulded with a lower peripheral hand grip portion 101a having a rectangular well or recess 101b (see FIG. 6) snugly receiving a standard dimension off the shelf rectangular sponge 102. Advantageously, reservoir/pouch 101 occupies a substantial volume in relation to sponge 102 to avoid the necessity of frequent filling with cleansing/washing agent.

Reservoir/pouch 101 has a centrally located inlet valve 101c (see FIG. 6) on an upper surface 101d, for receiving a suitable cleansing/washing agent. The reservoir/pouch 101 is provided with a single outlet nozzle 101e, positioned on a lower surface 101f of the reservoir.

The hand grip portion 101a has a skirt S with opposed, vertical curved wall ribbing 101g and 101h that can be gripped and squeezed together to dispense agent from the reservoir/pouch 101 through outlet nozzle 101e into and through pores in the sponge 102, in a manner that should readily be envisaged.

Pouch/reservoir 101 substantially spans the upper surface of the sponge 102 to allow agent to be dispensed in a readily controlled manner upon squeezing.

The reservoir/pouch 101 and handgrip portion 101a may be manufactured integrally or as separate parts.

Sponge 102 may be replaceable once dirty or worn out.

Reservoir/pouch 101 and sponge 102 may be used with a separate glove on the hand if required. The sponge may be fitted with an additional scourer member (not shown).

FIG. 7a shows an assembly 200 of a dome-shaped reservoir/pouch 201 and sponge 202.

FIG. 7b shows the reservoir/pouch 201 before being bonded/attached to an upper surface 202a of the sponge 202.

Inlet valve 201a is centrally located on an upper surface 201b of the reservoir/pouch 201 with an outlet nozzle 201c being located on a lower surface 201d of the reservoir/pouch.

The sponge 202 is shaped for easy squeezing to dispense cleaning agent from the reservoir/pouch 201 through pores in the sponge and around bottom scourer layer 203 on sponge 202.

Reservoir/pouch 101, 201 may be rigid or flexible/collapsible.

It is to be understood that the scope of the present invention is not to be unduly limited by the particular choice of terminology and that a specific term may be replaced or supplemented by an equivalent or generic term e.g. ‘having’ may be replaced by ‘comprising’ or ‘including’. Further it is to be understood that individual features, method or functions or combinations thereof relating to the cleaning/washing aid/applicator means and/or pouch/reservoir might be patentably inventive. The singular may include the plural and vice versa.

Additionally, any range mentioned herein for any parameter or variable shall be taken to include a disclosure of any derivable sub-range within that range or of any particular value of the variable or parameter arranged within, or at an end of, the range or sub-range.

1-15. (canceled)

16. A reservoir or pouch, in use, bonded or connected to a sponge or washing/cleaning applicator means, said reservoir/pouch having an inlet for receiving a cleansing or washing or treatment agent or material and at least one outlet nozzle or valve through which said agent/material may be dispensed wherein the reservoir/pouch has a hand grip portion that holds or secures the sponge/applicator means, said hand grip portion being provided with a recess or well for snugly receiving the sponge or washing/cleaning applicator means.

17. The reservoir/pouch as claimed in claim 16, wherein the sponge/applicator means is removably securable in the hand grip portion.

18. The reservoir/pouch as claimed in claim 16, wherein, in use, the hand grip portion is squeezable to dispense the cleansing or washing or treatment agent/material from the reservoir/pouch from said at least one outlet nozzle onto or into said sponge/applicator means and, preferably, wherein the recess/well is located on the underside of the hand grip portion.

19. The reservoir/pouch as claimed in claim 16, wherein the inlet is located on an upper part of the reservoir/pouch.

20. The reservoir/pouch as claimed in claim 16, wherein said at least one outlet nozzle or valve is on a lower part of the reservoir/pouch adjacent the sponge/applicator means, in use.

21. The reservoir/pouch as claimed in claim 16, wherein the reservoir/pouch is bonded or moulded to the hand grip portion.

22. The reservoir/pouch as claimed in claim 16, wherein the reservoir/pouch is manufactured as an integral one part unit or as a two part assembly (separate reservoir/pouch and hand grip parts) said reservoir/pouch, preferably, being replaceable on the hand grip portion.

23. The reservoir/pouch as claimed in claim 16, wherein the sponge/applicator means is removable from the hand grip portion to allow replacement when worn out or dirty or is permanently bonded thereto.

24. The reservoir/pouch as claimed in claim 16, wherein the hand grip portion is made from silicone or other plastics/elastomeric materials.

25. The reservoir/pouch as claimed in claim 16, wherein, in use, being connected to an upper surface of a sponge/applicator means and, preferably, further characterised in that in the reservoir/pouch is bonded to said upper surface.

26. The reservoir/pouch as claimed in claim 16, wherein it is refillable with washing/cleansing/treatment agent or material.

27. The reservoir/pouch as claimed in claim 16, wherein it is of a substantial size (perhaps 30% to 100% the volume of the sponge/applicator means) and/or spans (or perhaps 30% to 100%) substantially an upper surface of the sponge/applicator means.

28. The reservoir/pouch as claimed in claim 16, wherein a control button being provided to release or help release said agent/material.

29. A cleaning or washing aid comprising a glove and a separately formed, self-contained reservoir or pouch, in use, bonded or attached to the outside of the a palm of the glove, said reservoir/pouch having an inlet for receiving a cleansing or washing or treatment agent or material and at least one outlet nozzle or valve through which said agent/material can be dispensed and wherein the inlet is located at or adjacent to the outside of the palm of the glove, said inlet being visible or exposed on or adjacent to the palm of the glove, the aid being provided with cleaning/scouring/agitating/polishing/treatment/applicator means and the pouch/reservoir being manufactured separately to the glove with an exterior sponge or other cleaning/scouring/agitating/polishing/treatment/applicator surface attached thereto to create a unit or sub-assembly that is bonded/attached to the outside of the palm of the glove and. preferably, in which the inlet extends below the sponge or cleaning/scouring/agitating/polishing/treatment/applicator and/or in which the pouch/reservoir is provided with a single outlet nozzle/valve, preferably, located on the outside of the palm of the glove or, alternatively, includes a plurality of outlet nozzles e.g. located on fingertips of the pouch/reservoir itself.

30. A method of making a washing/cleaning aid comprising:
1) manufacturing a self-contained reservoir or pouch having an inlet and at least one outlet nozzle or valve,
2) bonding or attaching said reservoir or pouch to the outside of a palm of a glove of standard format
3) Attaching said reservoir/pouch to a sponge or other exterior applicator surface, preferably as a unit or sub-assembly bonded or attached to the outside of the palm of said glove, or
a kit of parts comprising a pair of gloves and a plurality of pouches and, preferably, a plurality of sponge members (or other scourer/applicator means), or
a washing aid comprising a glove and a reservoir or pouch in which part of a rubber glove or other waste rubber material is sealed on the palm of another glove to create a pouch/reservoir with sponge/applicator means placed over the top of said pouch/reservoir.
